(19) United States
(12) Patent Application Publication
(10) Pub. No.: US 2026/0295506 A1
(43) Pub. Date: Oct. 1, 2026

(54) USE OF CLOSED OR SEMI-CLOSED LOOP REGENERATION OF MOLECULAR SIEVE IN DEHYDRATION DRIERS USING NITROGEN OR PROCESS GASES IN ALCOHOL TO OLEFINS PROCESSES

(71) Applicant: UOP LLC, Des Plaines, IL (US)

(72) Inventors: Ernest J. Boehm, Hanover, IL (US); Jennifer Behrens, Chicago, IL (US); Matthew C. Cole, Evanston, IL (US); Ian G. Horn, Streamwood, IL (US); Sourabh Maithil, Gurgaon (IN); Pourang Shamsi, Richmond, TX (US); Michael Tobin, Elmhurst, IL (US); Erick J. Bennett, III, New Lenox, IL (US); Gregory R. Werba, Arlington Heights, IL (US); Audra Van Doorn, Oak Park, IL (US); Jeannie M. Blommel, Oregon, WI (US)

(21) Appl. No.: 19/432,387

(22) Filed: Dec. 24, 2025

(30) Foreign Application Priority Data
Mar. 25, 2025 (IN) 202511027879

(51) Int. Cl. B01D 53/047; B01D 53/26

(52) U.S. Cl. CPC B01D 53/047; B01D 53/261; B01D 2253/116; B01D 2257/80

(57) ABSTRACT

Processes and apparatus semi-closed loop or closed loop regeneration for molecular sieve adsorbers using N₂ or a process gas stream are described. With a semi-closed loop design or closed loop designs, a process gas could be used as the regenerant gas. The process gases could be recovered to the process unit upstream of the driers and reprocessed through the unit. With N₂ as the regenerant the loop would have to be purged and make-up N₂ added.

### CROSS-REFERENCES TO RELATED APPLICATIONS

This application claims the benefit of Indian Patent Application number 202511027879 filed on Mar. 25, 2025, the entire disclosure of which is incorporated herein by way of reference.

### BACKGROUND

With government mandates and subsidies making carbon-neutral jet fuel a profitable product, there is a great interest in finding effective and efficient means of producing it.

Technologies such as methanol to olefins (MTO), methanol to jet fuel (MTJ), methanol to propylene (MTP), ethanol to jet fuel (ETJ), and the like, which convert alcohols to olefins and in some cases subsequently convert the olefins to transportation fuels, generate large quantities of water. C1 to C3 conversion units are currently in commercial operation, and there have been discussions of expanding these processes to convert C4 to C6 alcohols to olefins.

The product from an MTO reactor is quenched in a quench tower, cooled, and the bulk of the water is removed in a direct contact condenser (product separator). The gas is sent to a light olefin recovery process concentration unit (LORP concentration unit) which is a preparation for conditioning the gas for fractionation. The LORP concentration unit compresses the MTO reactor effluent, separates a portion of oxygenates in the stream, and neutralizes acids before the gas is dehydrated and cooled. The dehydration is typically accomplished utilizing molecular sieve-based driers.

The molecular sieve driers are designed to have a small pore size that allows the adsorption of water; for example, the use of a 3 A molecular sieve is typical in this operation. The small pore size allows hydrocarbons to pass over the sieve and not be adsorbed, while water is adsorbed and removed from the reactor effluent. The water is tightly bound by polar interaction with the molecular sieve. Once saturated, the adsorbent bed must be taken offline for regeneration. Typically, another recently regenerated adsorbent bed is placed back into service to ensure plant operation is not interrupted. Some current regeneration designs in this technology space reduce the pressure of the vessel to that of the regeneration loop and then use a high temperature regeneration step with nitrogen followed by a cooling step in a once through regeneration process. The nitrogen is then flared off. However, there are two issues with once through nitrogen regeneration. First, if the nitrogen contains any residual hydrocarbon, many locations require that it be processed in either flares or thermal oxidizers to ensure complete destruction of the hydrocarbon to CO₂ and water. This adds fuel cost, increases carbon emissions due to fuel firing, and increases capital cost for the equipment. The second problem is that N₂ separation units are costly, energy intensive, and have a large carbon footprint. As a result, it would be desirable to minimize N₂ consumption in drier regeneration for new and existing complexes.

One way to reduce the nitrogen consumption is to incorporate a semi-closed loop design with nitrogen or another regenerant gas. In the semi-closed loop process, dry regenerant gas is heated to drive the water off the molecular sieve adsorbent. The regenerant gas is cooled, typically to air cooling or water-cooling temperature (e.g., 30° C. to 50° C. (85° F. to 122° F.)), and the water is separated out in a knockout drum. The regenerant gas is dried in a molecular sieve drier separate from the product driers and recycled to the heater for the regenerant gas. If there are contaminants from the reactor effluent on the molecular sieve that will build up in the regeneration loop, a purge of regenerant gas can be sent out of the loop and fresh regenerant gas can be added. Semi-closed loop designs are typically designed for 4-50% purge and fresh regenerant gas make up.

Therefore, there is a need to reduce nitrogen use in new and existing alcohol to olefin and/or transportation fuel complexes.

### BRIEF DESCRIPTION OF THE DRAWINGS

FIG. 1 is an illustration of an open loop N₂ regeneration process.

FIG. 2 is an illustration of one embodiment of a semi-closed loop regeneration process of the present invention.

FIG. 2A is an illustration of one embodiment of a semi-closed loop regeneration process for the auxiliary bed of FIG. 2.

FIG. 3 is an illustration of another embodiment of a semi-closed loop regeneration process of the present invention.

FIG. 4 is an illustration of another embodiment of a semi-closed loop regeneration process of the present invention.

FIG. 5 is an illustration of another embodiment of a semi-closed loop regeneration process of the present invention.

FIG. 6 is an illustration of one embodiment of a light olefin recovery process concentration unit showing the regenerant gas stream.

FIG. 7 is an illustration of one embodiment of a light olefin recovery process fractionation unit showing one source for the regenerant gas.

### DETAILED DESCRIPTION

The emergence of renewable fuels has made the reduction of nitrogen consumption in the MTJ/ETJ technology a top priority because nitrogen consumption and subsequent destruction via flare or thermal oxidizer is a barrier to expansion of the technology. About 80% of the N₂ used in the MTO section of an MTJ complex is used in the regeneration of the LORP concentration product driers. If the regenerant gas is N₂, much less nitrogen would be required in a semi-closed loop process, e.g., 20% or less of the amount needed for the LORP concentration product driers Depending on the configuration and regenerant gas chosen, for a unit of 2000 MTD of methanol feed to a methanol to jet fuel unit, the N₂ consumption could be reduced by 60 to 75 metric tons per day using a semi-closed loop or fully closed loop regeneration scheme. If one of the alternate regenerant gases is used, the only nitrogen needed would be as a backup regenerant gas if the primary regenerant gas was temporarily unavailable, such as during startup or a process upset.

The present invention makes methanol to jet and similar technologies more competitive by reducing N₂ consumption. It does this by changing the liquid and vapor regeneration system from once through N₂ regeneration to semi-closed loop or closed loop regeneration using N₂ or a process gas stream. If a semi-closed loop design is employed, a process gas such as deethanizer overhead, C₂ splitter overhead, or propylene from a C₃ splitter overhead could be used as the regenerant gas. The process gases could be recovered to the process unit upstream of the driers and reprocessed through the unit, while N₂ would have to be purged and constantly made up, making process gases attractive as a regenerant. If there are no contaminants that build up, a closed loop design can be used in which no purge or make up gas is required other than make up from the drier switching in and out of regeneration.

As discussed above, the LORP concentration process compresses the reactor effluent, treats it to reduce the oxygenate content, and reacts the CO₂ in a caustic scrubber. The effluent product gas is then chilled, and water is separated out in a three phase knock out drum at a temperature of 4° C. to 21° C. (40° F. to 50° F.), typically about 15° C. (59° F.). The chilling of this stream causes the reactor effluent to separate into three phases: an aqueous phase, which is removed as free water in the knockout drum; a water-saturated hydrocarbon vapor phase, which exits the drum as the overhead stream and goes to the MTO vapor product driers; and a water-saturated hydrocarbon liquid phase, which is pumped from the knockout drum to the MTO liquid product driers.

Typically, both sets of driers are configured so that one drier bed is in adsorption, i.e., dehydrating the reactor effluent, and a second bed is being regenerated followed by a stand-by step. The second bed is in standby until it is brought back into the process flow path for the dehydration step so that the first bed can be taken out of the process flow path and regenerated. Once a bed is saturated, mechanical valving is used to take the standby bed into parallel flow with the water saturated bed. The water saturated bed is isolated into the regeneration flow path which is independent of the reactor effluent. The current practice for regeneration with nitrogen is to heat the nitrogen in a heater and pass it over the molecular sieve adsorbent at a pressure of 25 to 150 psig and a temperature of 180° C. to 315° C. (356° F. to 600° F.) to remove water from the adsorbent. As discussed above, in many geographical locations, the nitrogen must be sent to a flare or thermal oxidizer to meet emissions requirements.

One aspect of the invention to reduce nitrogen consumption is to implement a semi-closed loop regeneration design. Make-up regenerant gas is brought into a circulating regenerant gas loop and can be introduced at the discharge coalescer or regenerant compressor suction drum or at the inlet of the regenerant drier, depending on the system pressure. The regenerant gas is compressed in the loop and passes through a regenerant recycle compressor suction cooler to a recycle compressor knockout drum. The gas passes to the recycle compressor and is cooled using air, water, or refrigerant (e.g., compressed and condensed propane, propylene, ethane, ethylene, or combinations thereof) in the regenerant recycle process cooler to generally in the range of 15° C. to 54° C. (60° F. to 130° F.) (e.g., typically, 30° C. to 50° C. (85° F. to 122° F.) for air or water cooling; temperatures at the lower end may require a chiller). Finally, the gas is sent to a regenerant recycle compressor discharge coalescer, which separates condensed water from the gas. The gas is sent to the regenerant drier to reduce the gas water content from saturation to as low as 0.1 wt ppm. Following the regenerant drier, the gas is sent to a heater to increase the gas temperature to 180° C. to 315° C. (356° F. to 600° F.). The hot gas passes through the product driers to remove water from the adsorbent.

Heating the bed with hot gas at low pressure drives off water in a thermal pressure swing desorption mechanism. After exiting the drier, the gas is then recycled to the regenerant recycle compressor suction cooler. Before entering the cooler, a purge can be used to prevent contaminants, such as oxygenates, from building up in the loop. The amount that is purged from the loop is made up in the location specified above. For N₂, the purge could be sent to locations such as flare or a thermal oxidizer. After the hot regeneration step, the drier is cooled with the regenerant gas (the heater is powered down or bypassed) to the temperature that can be achieved by cooling the regenerant gas with air or water. Liquid driers will have additional steps for filling and draining of hydrocarbons to avoid product loss. There is a separate regeneration cycle for the regenerant drier as well.

Both sets of driers are regenerated using a vapor phase regenerant. If the driers are designed to have the same adsorption cycle, and if the regeneration cycle times are similar, there could be one common set of regeneration equipment for the two driers, reducing the capital cost and equipment count for the process. Liquid driers have liquid draining and filling steps that the vapor driers do not, but this is not an impediment to using common regeneration equipment, as long as adequate time is built into the sequences for all the steps—that is, the vapor driers could incorporate “HOLD” steps during the drain time of the liquid driers.

In some embodiments, the driers are synchronized, while in other embodiments, the driers run on independent cycles.

Because MTO, MTJ, and ETJ have driers that only remove water, there may not be contaminants coming off the adsorbent into the regenerant gas. In this case, there could be a loop without a purge or with a very low purge from 0-10% of the regenerant. If there is no purge, the system is considered to be a closed loop design. There will be some loss of regenerant gas to the process during switching of driers and during filling and drain steps, so regenerant gas will need to be made up even in a closed loop design.

The process may not always be able to utilize process gas as a regenerate gas at start-up or during a process upset. In this case, a system could be configured with both N₂ and a process gas as a regenerant. The recycle compressor can be designed for the various gases described and N₂ in a common machine. This design can reduce N₂ in situations where process gas is not available and eliminate the need for N₂ if process gas is available.

MTO and MTJ have vapor and liquid driers, while ETJ has an all-vapor phase drier design. MTJ and MTO could be operated at a higher adsorber temperature and have an all-vapor design, removing the liquid driers and passing the entire product stream through the vapor driers for water removal.

Gases other than N₂, such as process gases, can be used as the regenerant gas. Alternative regenerant gases include, but are not limited to C₂ splitter overhead (in an MTO unit), deethanizer overheads (in MTJ, MTO, or ETJ units), C₃ splitter overhead (MTO), or propylene product stream, or combinations thereof. The acetylene can be removed from the C₂ splitter overhead stream or the deethanizer overhead stream in a catalytic acetylene convertor to a level typically in the range of 0.5 to 50 wt ppm. The acetylene convertor can also be located on the feed stream to the deethanizer, or the C2 splitter column as alternative configurations.

These regeneration gas sources are downstream of the vapor and liquid driers in the process. In a semi-closed loop design, the regenerant gas pressure could be set between 40 and 350 psig, allowing the gas to return to the LORP concentration process at either the MTO product compressor suction or upstream of the LORP concentration MTO drier feed chiller. These alternate regenerant gases allow the regenerant be drawn from the process and reenter the process to be reprocessed without the need for the gas to go to a thermal oxidizer or flare, as is the case with N₂. These process gas regenerants are taken from within the LORP fractionation section. For an MTO or MTJ complex, if both one vapor drier and one liquid drier were to use these alternate gases in once through mode at the same time, 20 to 25 percent of the product stream would be utilized for regeneration, causing the oversizing of LORP concentration equipment to accommodate the higher flow and causing upsets to downstream units. The semi-closed loop design can reduce the gas rate to 0.5 to 8% of the amount of gas required for the once-through scheme. The semi closed loop design will reduce equipment sizing of the LORP concentration equipment to handle regenerant recycling compared to the open loop design, as the equipment is upsized to only handle the regenerant gas purge flow in the semi-closed loop design, but the full regeneration gas flow rate in the open loop design. If the regenerant gas stream flow is not kept constant when regeneration gas isn't needed, a once-through process will result in large swings in gas rates (e.g., 20-25%). This large change in flow would cause upsets in downstream units (e.g., polyethylene (PE) and polypropylene (PP) polymerization units for the MTO process, and sustainable aviation fuel (SAF) production units for the MTJ process), as well as the MTO LORP fractionation process. This type of process upset would lead to problems with products which do not meet the specifications. Closed loop or semi-closed loop operation significantly reduces the size of these upsets, if regeneration gas flow rate it turned on and off.

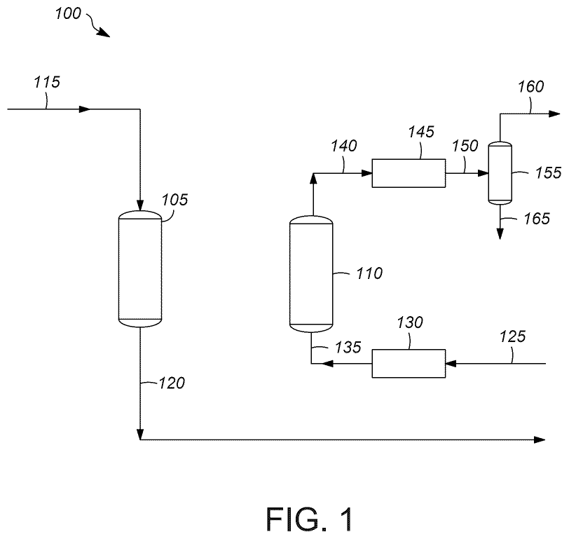

FIG. 1 is an illustration of a two bed N₂ once-through regeneration process 100. There are two beds, first bed 105 and second bed 110. The process alternates between the two beds for adsorption and regeneration.

Process gas stream 115 comprising a hydrocarbon is sent to the first bed 105 where the water is adsorbed onto the molecular sieve adsorbent. The first bed 105 can be at high pressure (e.g., 260 psig) and low temperature (e.g., 14° C.). The dried process gas stream 120 is sent to a fractionation zone (not shown).

An N₂ stream 125 is sent to a heater 130. The heated N₂ stream 130 is sent to second bed 110 to remove the adsorbed water. The second bed 110 can be at low pressure (e.g., 50 psig) and high temperature (e.g., 242° C.). The water-laden N₂ stream 140 is sent to cooler 145 where it is cooled to e.g., 40° C. The cooled N₂ stream 150 is sent to knockout drum 155 where is separated into dehydrated N₂ stream 160 and water stream 165. The water stream 165 could be condensed and sent to a waste water treatment facility or a water stripper (not shown). The dehydrated N₂ stream 160 is flared or sent to a thermal oxidizer (not shown).

When the first bed 105 becomes saturated, and the second bed 110 has been regenerated, the process gas stream 115 is sent to second bed 110, and the heated N₂ stream 135 is sent to the first bed 105.

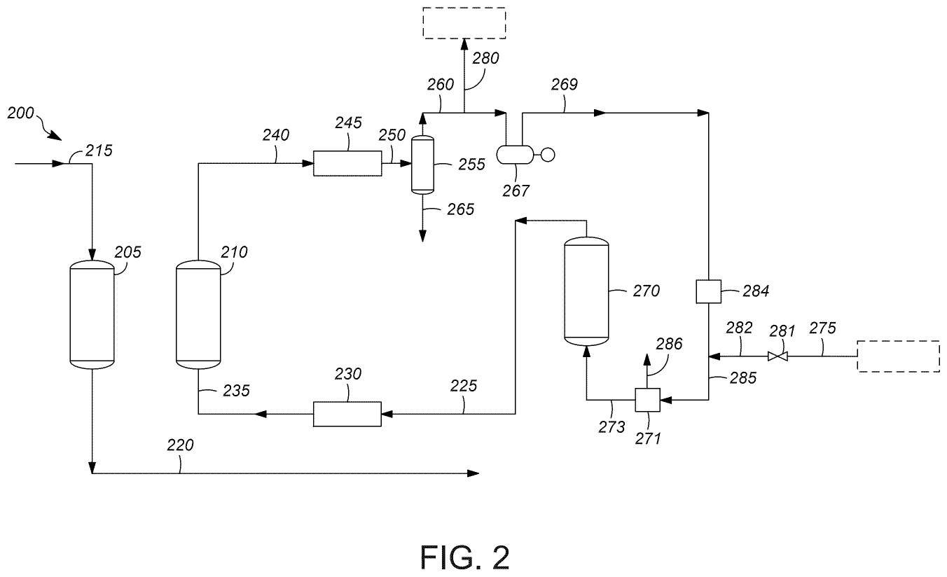

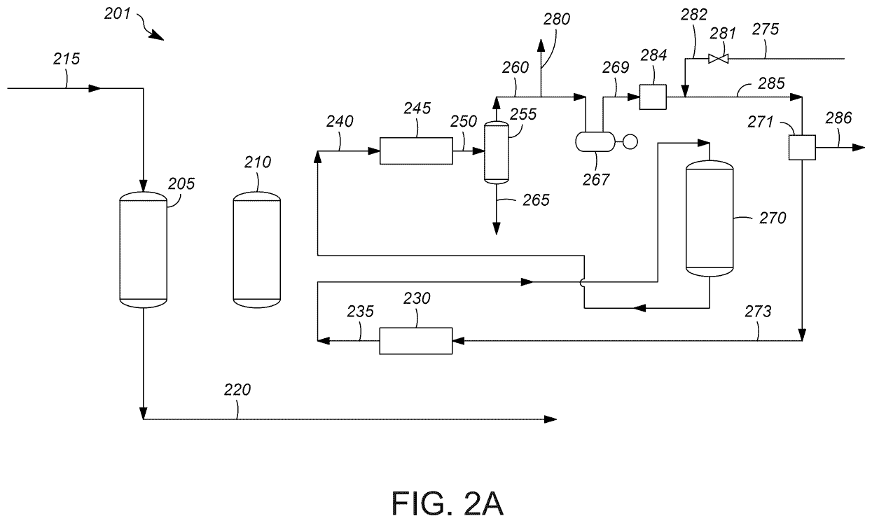

FIG. 2 is an illustration of a two bed regenerant gas semi-closed loop regeneration process 200. There are two beds, first bed 205 and second bed 210. The process alternates between the two beds for adsorption and regeneration.

Process gas stream 215 comprising a hydrocarbon is sent to the first bed 205 where the water is adsorbed onto the molecular sieve adsorbent. The first bed 205 can be at high pressure (e.g., 260 psig) and low temperature (e.g., 14° C.). The dried process gas stream 220 is sent to a fractionation zone (not shown).

A dry regenerant gas stream 225 is sent to a heater 230. The heated regenerant gas stream 235 is sent to second bed 210 to remove the adsorbed water. The second bed 210 can be at low pressure (e.g., 50 psig) and high temperature (e.g., 242° C.). The water-laden regenerant gas stream 240 is sent to cooler 245 where it is cooled to e.g., 40° C. The cooled regenerant gas stream 250 is sent to knockout drum 255 where is separated into dehydrated regenerant gas stream 260 and water stream 265.

The dehydrated regenerant gas stream 260 is sent to compressor 267, and the compressed dehydrated regenerant gas stream 269 is sent to a cooler 284 to cool to e.g. 40° C. and condense water. Stream 285 is sent to a coalescer 271 to remove condensed water stream 286. Stream 273 now cooled, compressed, and dehydrated is sent to auxiliary adsorbent bed 270 to dry the compressed dehydrated regenerant gas stream 269 forming dry regenerant gas stream 225.

Make-up regenerant gas stream 275 is added intermittently to the compressed dehydrated regenerant gas stream 285 (as shown), Other options are to the dehydrated regenerant gas stream 260 (not shown), or to the second cooled regenerant gas stream 285 between the second cooler (or heat exchanger) 284 and the coalescer 271 (not shown), as needed, and purge gas stream 280 is removed periodically from the dehydrated regenerant gas stream 260 (shown) or the water-laden regenerant gas stream 240 (not shown) as needed, but stream 285 is the ideal location for low pressure operation for maximum water removal thus minimum cost.

Makeup regenerant gas stream 275 may be available at a higher pressure than regeneration system pressure. In this case, it is expanded and regeneration gas consisting of light hydrocarbon (primarily C2) is cooled through the J-T valve (not shown on stream 275) and injected after the discharge cooler to reduce remove additional water from the circulating regeneration gas. By removing additional water, the size of the molecular sieve is reduced, and time for regeneration is minimized.

FIG. 2A is an illustration of regeneration of the auxiliary adsorbent bed 270 using the same equipment that regenerants first and second beds 210 and 205. When the second bed 210 has completed regeneration, bed 270 is saturated with water and requires regeneration. Bed 270 is regenerated using the same equipment and streams as were used to regenerant bed 210, but the flow direction is altered.

In this stage, the first bed 205 is still being used for adsorption, and the second bed has been regenerated and is ready to be used. Instead of being sent to the second bed 210, the heated regenerant gas stream 235 is sent to the auxiliary adsorption bed 270 to remove the adsorbed water. The auxiliary bed 210 can be at low pressure (e.g., 50 psig) and high temperature (e.g., 242° C.). The water-laden regenerant gas stream 240 from the auxiliary adsorption bed 270 is sent to cooler 245 where it is cooled to e.g., 40° C. The cooled regenerant gas stream 250 is sent to knockout drum 255 where it is separated into dehydrated regenerant gas stream 260 and water stream 265.

The dehydrated regenerant gas stream 260 is sent to compressor 267, and the compressed dehydrated regenerant gas stream 269 is sent to a cooler 284 to cool to e.g. 40° C. and condense water. Stream 285 is sent to a coalescer 271 to remove condensed water stream 286. Stream 273 now cooled, compressed, and dehydrated is sent to heater 230.

Regeneration of bed 270 will completed and the process will change bed 210 into service and change bed 205 into regeneration (which will be completed the same as bed 210 as shown in FIG. 2).

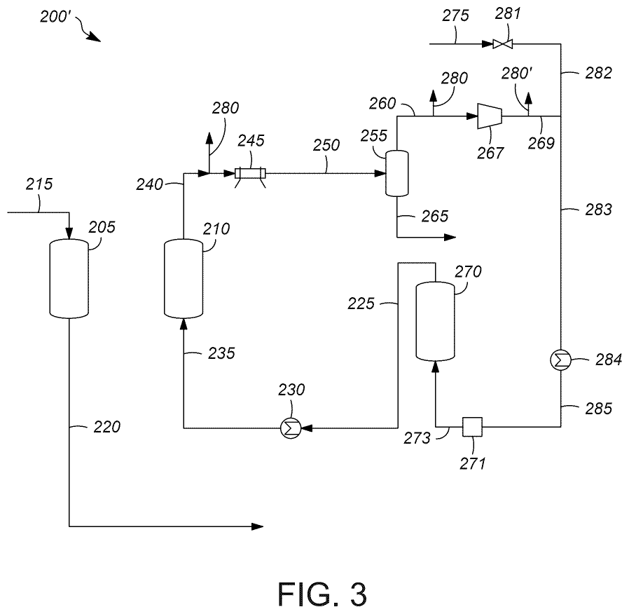

FIGS. 3-5 are illustrations of alternate versions of two bed regenerant gas semi-closed loop regeneration process 200. These arrangements can be applied to any semi-closed loop system in which the make-up gas is at significantly higher pressure than the regenerate gas loop. It has a larger effect on systems with an auxiliary adsorbent bed, but is also applicable to processes without an auxiliary bed. When an auxiliary adsorbent bed is present, these arrangements are designed to minimize the size of the auxiliary adsorbent bed 270, leading to lower cost and a more efficient process. When the auxiliary bed is not present (not shown), the main adsorbent bed 210 would be used. The main adsorbent bed would be larger than when the auxiliary bed is present to account for the water uptake. Although this arrangement can be used, it will likely not be economical because the auxiliary bed is usually much smaller than the main bed.

In FIG. 3, the purge gas stream 280 may be taken from the water-laden regenerant gas stream 240, or the compressed dehydrated regenerant gas stream 269, or the dehydrated regenerant gas stream 260.

In addition, the make-up regenerant gas stream 275 is sent through a valve 281 (shown) or expander (not shown) to decrease the pressure and cool the make-up regenerant gas stream 275. The cooled make-up regenerant gas stream 282 is combined with the compressed dehydrated regenerant gas stream 269 (or the dehydrated regenerant gas stream 260). The combined regenerant gas stream 283 is sent to a second cooler 284 forming a second cooled regenerant gas stream 285. The second cooled regenerant gas stream 285 is sent to a coalescer 271, where liquid droplets are removed. Stream 273 out of the coalescer is sent to the auxiliary adsorbent bed 270 where water is removed.

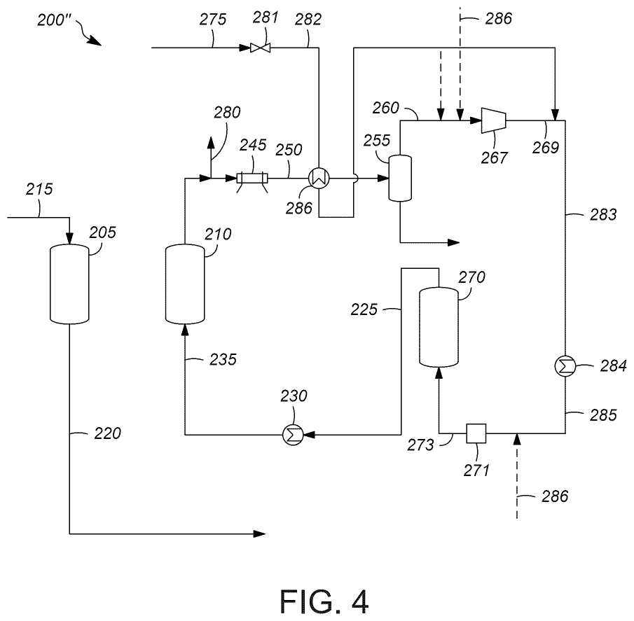

FIG. 4 shows an embodiment which allows for the recovery of heat from the make-up gas stream. In this case, the make-up regenerant gas stream 275 is brought through a valve 281 to decrease pressure and cool the make-up regenerant gas stream 275. The cooled make-up gas stream 282 is brought through a make-up gas heat exchanger 286 that is between the cooler 245 and the knockout drum 255 to cool the cooled water laden regeneration gas stream 250 beyond that of water or air cooling and knock out any additional water in the cooled water laden regeneration gas stream 250. The make-up gas stream 282 exits the make-up gas heat exchanger 286 and can either be mixed into the regeneration loop downstream of the compressor 267 (as shown) or upstream of the compressor 267 (dotted line). If it is brought in downstream of the compressor 267, this would reduce the operating cost of the compressor 267. However, if a few extra degrees of cooling duty are needed, the make-up gas stream 282 could enter the suction of the compressor 267.

A second location for the make-up gas heat exchanger 286 is between the knockout drum 255 and the suction of the compressor 267. This arrangement may not allow for additional water removal from the system, but the colder gas would reduce the operating cost of the compressor 267. A third possible location for the make-up gas heat exchanger 286 is the second cooled regenerant gas stream 285 between the second cooler 284 and the coalescer 271. If the second cooler 284 is not present, the location for the make-up gas heat exchanger 286 would be between the compressor 267 and either coalescer 271 (if present) or the auxiliary adsorbent bed 270. This arrangement can allow for additional water removal from the system when a coalescer 271 is present, and the second cooled regenerant gas stream 285 (or the combined regenerant gas stream 283) would allow for a smaller auxiliary adsorbent bed 270.

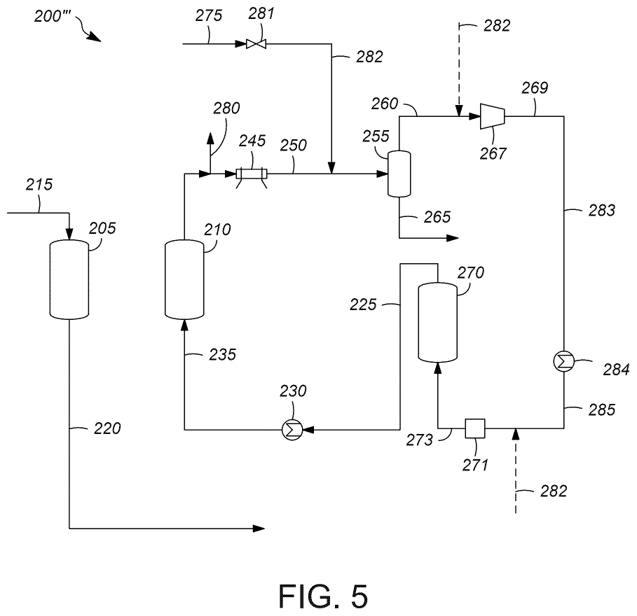

FIG. 5 illustrates a process in which the make-up regenerant gas stream 275 is directly injected into the regeneration loop. The make-up regenerant gas stream 275 is sent through a valve 281 to decrease pressure and cool the make-up gas stream.

The cooled make-up regenerant gas stream 282 is injected between the cooler 245 and the knockout drum 255 to cool the cooled water laden regeneration gas stream 250 beyond that of water or air cooling and knock out any additional water in the regeneration gas stream.

A second location for the direct injection of the cooled make-up regenerant gas stream 282 is between the knockout drum 255 and the suction of the compressor 267. This may not allow for additional water removal from the system, but the colder cooled make-up regenerant gas stream 282 here would reduce the operating cost of the compressor 267.

A third possible location for the direct injection of the cooled make-up regenerant gas stream 282 is in the second cooled regenerant gas stream 285 between the second cooler 284 and the coalescer 271. If the second cooler 284 is not present, it would be between the compressor 267 and either coalescer 271 (if present) or the auxiliary adsorbent bed 270. This can allow for additional water removal from the system when a coalescer 271 is present, and the colder cooled make-up regenerant gas stream 282 would allow for a smaller auxiliary adsorbent bed 270.

The above locations are believed to be optimal for most cooling duty and optimized water removal from the process. However, other locations may possibly be used.

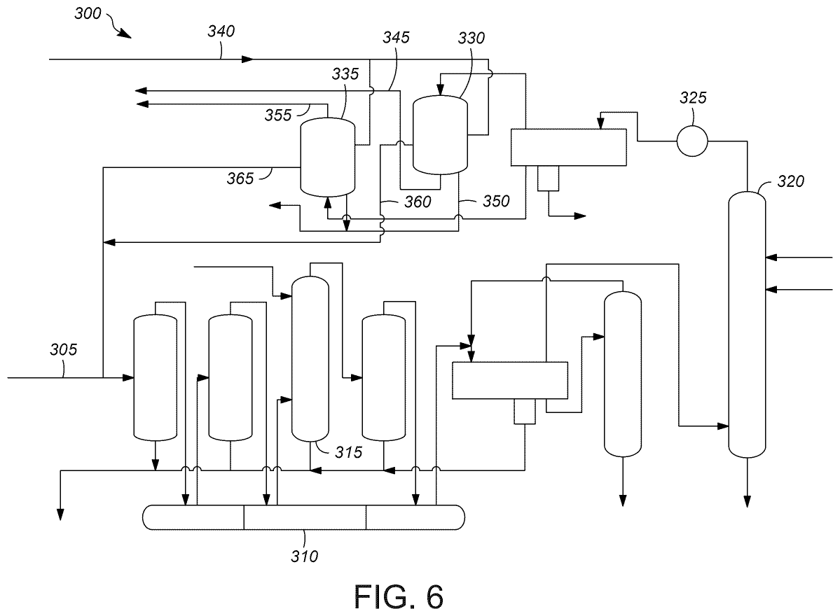

FIG. 6 shows one embodiment of light olefin recovery process (LORP) concentration unit 300 which is a preparation for conditioning the gas for fractionation. The LORP concentration unit 300 compresses the MTO reactor effluent stream 305 in a product compression unit 310. A portion of oxygenates in the MTO reactor effluent stream 305 is removed in an oxygenate absorber 315. Acids in the gas are neutralized in a caustic scrubber 320. The gas is cooled in a chiller 325 and dehydrated in vapor product drier 330 and liquid product drier 335.

The regenerant process gas stream 340 from the LORP fractionation unit (shown in FIG. 4) is sent to the vapor product drier 330 and liquid product drier 335. The dried vapor olefin stream 345 is sent to the LORP fractionation unit.

The liquid stream 350 from the vapor product drier 330 is sent to the liquid product drier 335 where it is dried. The dried liquid olefin product stream 355 is sent to the LORP fractionation unit.

The spent regenerant gas stream 360 from the vapor product drier 330 and spent regenerant gas stream 365 from the liquid product drier 335 are returned to the product compression unit 310 comprising one or more stages at the beginning of the LORP concentration unit 300.

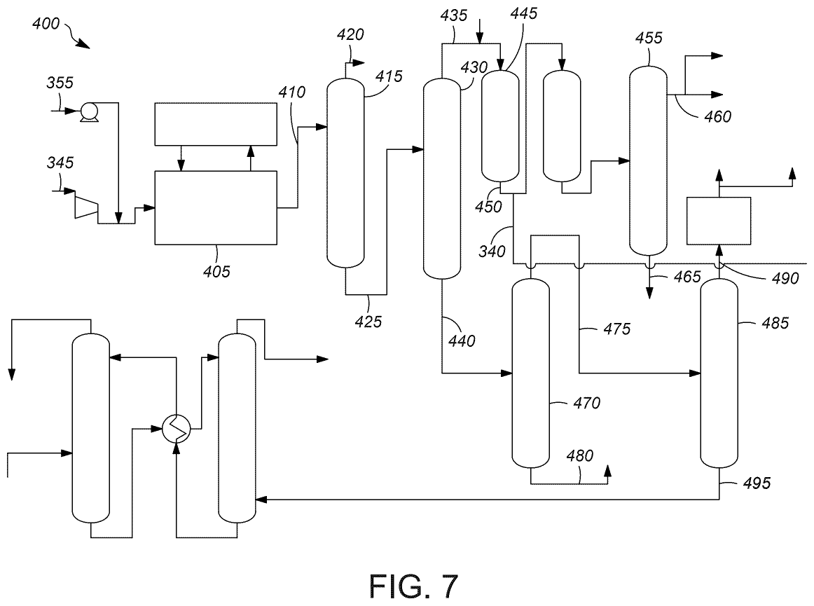

FIG. 7 illustrates one embodiment of a LORP fractionation unit 400. The dried liquid olefin product stream 355 and the dried vapor olefin stream 345 are chilled in chiller 405. The chilled olefin stream 410 is sent to demethanizer column 415 and separated into fuel gas stream 420 and demethanizer bottom stream 425.

Demethanizer bottom stream 425 is sent to deethanizer column 430 where it is separated into deethanizer overhead stream 435 and deethanizer bottom stream 440.

Acetylene is removed from the deethanizer overhead stream 435 in the acetylene converter 445 to form stream 450 with reduced acetylene content. The regenerant process gas stream 340 is a portion of stream 450.

The remainder of stream 450 is sent to the C₂ splitter where it is separated into C₂ splitter overhead stream 460 comprising ethylene and C₂ splitter bottom stream 465 comprising ethane. The C₂ splitter bottom stream 465 can be used as fuel gas. A side draw (not shown) on the C₂ splitter may also be present

The deethanizer bottom stream 440 is sent to depropanizer 470 where it is separated into depropanizer overhead stream 475 and depropanizer bottom stream 480. A side draw (not shown) on the deethanizer may also be present The depropanizer bottom stream 480 can be sent for further processing.

The depropanizer overhead stream 475 is sent to the C₃ splitter 485 where it is separated into C₃ splitter overhead stream 490 comprising propylene and C₃ splitter bottom stream 495 comprising propane. A side draw (not shown) on the C₃ splitter may also be present. The C₃ splitter bottom stream 495 can be sent for further processing.

### EXAMPLES

Table 1 represent an example of the regeneration of the first adsorber bed 205 as shown in FIG. 2 (200). Table 2 represents an example of the regeneration of the secondary adsorber bed that adsorbs water from the main adsorbers regeneration gas as shown in FIG. 2A (201).

TABLE 1
Example of FIG. 2 (200)

| Stream | 215 | 220 | 225 | 235 | 240 | 250 | 260 | 265 | 280 | 269 | 275 | 285 | 286 | 273 |
|---|---|---|---|---|---|---|---|---|---|---|---|---|---|---|
| Temp. | 15 | 14 | 34 | 232 | 227 | 36 | 36 | 36 | 35 | 52 | 32 | 35 | 34 | 34 |
| (° C.) | | | | | | | | | | | | | | |
| Pressure | 17.4 | 16.4 | 4.3 | 4 | 3.8 | 3.3 | 3.3 | 2.9 | 1.9 | 5.7 | 5.3 | 5.3 | 4.6 | 4.6 |
| (bar(g)) | | | | | | | | | | | | | | |
| Mass | 27737 | 22718 | 1290 | 1290 | 1642 | 1642 | 1302 | 340 | 197 | 1105 | 195 | 1300 | 2 | 1298 |
| Flow | | | | | | | | | | | | | | |
| (kg/hr) | | | | | | | | | | | | | | |

TABLE 2
Example of FIG. 2A (201)

| Properties | 215 | 220 | 225 | 235 | 240 | 250 | 260 | 265 | 280 | 269 | 275 | 285 | 286 | 273 |
|---|---|---|---|---|---|---|---|---|---|---|---|---|---|---|
| Temp. | 15 | 14 | 34 | 232 | 227 | 36 | 36 | 36 | 35 | 83 | 32 | 35 | 34 | 34 |
| (° C.) | | | | | | | | | | | | | | |
| Pressure | 17.4 | 16.4 | 4.3 | 4 | 3.8 | 3.3 | 3.3 | 2.6 | 1.9 | 5.4 | 5.1 | 5.3 | 4.4 | 4.3 |
| (bar(g)) | | | | | | | | | | | | | | |
| Mass | 27737 | 22718 | 1298 | 1298 | 1646 | 1646 | 1302 | 345 | 197 | 1105 | 195 | 1300 | 1.7 | 1298 |
| Flow | | | | | | | | | | | | | | |
| (kg/hr) | | | | | | | | | | | | | | |

In this example, no nitrogen is used, and ethylene gas was used. The ethylene gas is taken from the MTO unit and returned to another location in the MTO unit. Thus, the regeneration gas from the purge is used in the process, demonstrating that no flaring operation has been achieved. The ethylene gas used for regeneration is taken from and then returned to the MTO process. The reduction in nitrogen saves approximately $800,000 per year in operating costs and $400,000 per year in flaring costs. By reducing flaring, the yearly CO₂ emissions have been reduced by 2700 MT per year which considering tax credits for carbon emissions may save $50-85 per MT of CO₂.

### SPECIFIC EMBODIMENTS

While the following is described in conjunction with specific embodiments, it will be understood that this description is intended to illustrate and not limit the scope of the preceding description and the appended claims.

A first embodiment of the invention is a semi-closed loop or closed loop regeneration process for a molecular sieve adsorber in a light olefin concentration unit comprising heating a dry regenerant gas stream forming a heated regenerant gas stream, wherein the regenerant gas stream comprises a C₂ splitter overhead stream or a side-draw from a light olefin fractionation unit, or a deethanizer overhead stream or a side-draw from a light olefin fractionation unit, or a C₃ splitter overhead stream or a side-draw from a light olefin fractionation unit, or combinations thereof; introducing the heated regenerant gas stream into the molecular sieve adsorber to remove water from the molecular sieve adsorber forming a water containing regenerant gas stream; cooling the water containing regenerant gas stream to form a cooled water containing regenerant gas stream; separating water from the cooled water containing regenerant gas stream in a knockout drum forming a dehydrated regenerant gas stream and a water stream; removing additional water from the dehydrated regenerant gas stream forming the regenerant gas stream; introducing a portion of the dehydrated regenerant stream into the light olefin concentration unit. An embodiment of the invention is one, any or all of prior embodiments in this paragraph up through the first embodiment in this paragraph wherein introducing the portion of the dehydrated regenerant gas stream into the light olefin concentration unit comprises introducing the portion of the dehydrated regenerant gas stream into a product compressor unit of the light olefin concentration unit, or an oxygenate absorber of a DME stripper of the light olefin concentration unit, or a caustic scrubber, of the light olefin concentration unit, or combinations thereof. An embodiment of the invention is one, any or all of prior embodiments in this paragraph up through the first embodiment in this paragraph further comprising adding a make-up regenerant gas stream comprising regenerant gas to the dry regenerant gas stream, or the dehydrated regenerant gas stream, or a cooled dehydrated regenerant stream, or a cooled compressed dehydrated regenerant stream, or combinations thereof. An embodiment of the invention is one, any or all of prior embodiments in this paragraph up through the first embodiment in this paragraph further comprising expanding the make-up regenerant gas stream before adding the make-up regenerant gas stream. An embodiment of the invention is one, any or all of prior embodiments in this paragraph up through the first embodiment in this paragraph further comprising cooling a combination of the expanded make-up regenerant gas stream, and the dehydrated regenerant gas stream or a compressed dehydrated regenerant gas stream or a cooled dehydrated regenerant stream, or a cooled compressed dehydrated regenerant stream, or combinations thereof. An embodiment of the invention is one, any or all of prior embodiments in this paragraph up through the first embodiment in this paragraph further comprising heat exchanging the expanded make-up regenerant gas stream with the cooled water laden regenerant gas stream, or the dehydrated regenerant gas stream, or a compressed dehydrated regenerant gas stream, or a cooled dehydrated regenerant gas stream, or a cooled compressed dehydrated regenerant gas stream, or combinations thereof. An embodiment of the invention is one, any or all of prior embodiments in this paragraph up through the first embodiment in this paragraph further combining expanding the make-up regenerant gas stream before adding the make-up regenerant gas stream; and combining the expanded make-up regenerant gas stream with the cooled water laden regenerant gas stream, or the cooled dehydrated regenerant gas stream, or a compressed dehydrated regenerant gas stream, or a cooled compressed dehydrated regenerant gas stream, or combinations thereof. An embodiment of the invention is one, any or all of prior embodiments in this paragraph up through the first embodiment in this paragraph further comprising removing a purge regenerant gas stream from the dehydrated regenerant gas stream or the water laden regenerant gas stream. An embodiment of the invention is one, any or all of prior embodiments in this paragraph up through the first embodiment in this paragraph further comprising compressing the dehydrated regenerant gas stream before removing additional water from the dehydrated regenerant gas stream. An embodiment of the invention is one, any or all of prior embodiments in this paragraph up through the first embodiment in this paragraph further comprising cooling the dehydrated regenerant gas stream or the compressed dehydrated regenerant gas stream. An embodiment of the invention is one, any or all of prior embodiments in this paragraph up through the first embodiment in this paragraph wherein a pressure of the regenerant gas stream is in a range of 40 to 350 psig; or wherein a temperature of the heated regenerant gas stream is in a range of 180° C. to 315° C.; or both. An embodiment of the invention is one, any or all of prior embodiments in this paragraph up through the first embodiment in this paragraph further comprising introducing a supplemental regenerant gas comprising N₂ during a system start-up or during a system upset. An embodiment of the invention is one, any or all of prior embodiments in this paragraph up through the first embodiment in this paragraph wherein a vapor phase molecular sieve adsorber and a liquid phase molecular sieve adsorber share the semi-closed loop or closed loop regeneration apparatus.

A second embodiment of the invention is a semi-closed loop or closed loop regeneration process for a molecular sieve adsorber in a light olefin concentration unit comprising heating a dry regenerant N₂ gas stream forming a heated regenerant N₂ gas stream; introducing the heated regenerant N₂ gas stream into the molecular sieve adsorber to remove water from the molecular sieve adsorber forming a water containing regenerant N₂ gas stream; cooling the water containing regenerant N₂ gas stream to form a cooled water containing regenerant N₂ gas stream; separating water from the cooled water containing regenerant N₂ gas stream in a knockout drum forming a dehydrated regenerant N₂ gas stream and a water stream; removing additional water from the dehydrated regenerant N₂ gas stream forming the dry regenerant N₂ gas stream. An embodiment of the invention is one, any or all of prior embodiments in this paragraph up through the second embodiment in this paragraph further comprising adding a make-up N₂ gas stream comprising N₂ gas to the dehydrated regenerant N₂ gas stream, or a compressed dehydrated regenerant N₂ gas stream, or a cooled dehydrated regenerant N₂ stream, or a cooled compressed dehydrated regenerant N₂ stream, or combinations thereof. An embodiment of the invention is one, any or all of prior embodiments in this paragraph up through the second embodiment in this paragraph further comprising expanding the make-up N₂ gas stream before adding the make-up N₂ gas stream. An embodiment of the invention is one, any or all of prior embodiments in this paragraph up through the second embodiment in this paragraph further comprising cooling a combination of the expanded make-up N₂ gas stream and the dehydrated regenerant N₂ gas stream, or a compressed dehydrated regenerant N₂ gas stream, or a cooled dehydrated regenerant N₂ stream, or a cooled compressed dehydrated regenerant N₂ stream, or combinations thereof. An embodiment of the invention is one, any or all of prior embodiments in this paragraph up through the second embodiment in this paragraph further comprising heat exchanging the expanded make-up N₂ gas stream with the cooled water laden regenerant N₂ gas stream, or the dehydrated regenerant N₂ gas stream, or a compressed dehydrated regenerant N₂ gas stream, or a cooled dehydrated regenerant N₂ gas stream, or a cooled compressed dehydrated regenerant N₂ gas stream, or combinations thereof. An embodiment of the invention is one, any or all of prior embodiments in this paragraph up through the second embodiment in this paragraph further combining expanding the make-up N₂ gas stream before adding the make-up N₂ gas stream; and combining the expanded make-up N₂ gas stream with the cooled water laden regenerant N₂ gas stream, or the dehydrated regenerant N₂ gas stream, or a compressed dehydrated regenerant N₂ gas stream, or a cooled compressed dehydrated regenerant N₂ gas stream, or combinations thereof. An embodiment of the invention is one, any or all of prior embodiments in this paragraph up through the second embodiment in this paragraph further comprising removing a purge N₂ gas stream from the dehydrated regenerant N₂ gas stream, or the water laden regenerant N₂ gas stream, or combinations thereof. An embodiment of the invention is one, any or all of prior embodiments in this paragraph up through the second embodiment in this paragraph further comprising compressing the dehydrated regenerant N₂ gas stream before removing additional water from the dehydrated regenerant N₂ gas stream. An embodiment of the invention is one, any or all of prior embodiments in this paragraph up through the second embodiment in this paragraph further comprising cooling the dehydrated regenerant N₂ gas stream or the compressed dehydrated regenerant N₂ gas stream. An embodiment of the invention is one, any or all of prior embodiments in this paragraph up through the second embodiment in this paragraph wherein a pressure of the regenerant N₂ gas stream is in a range of 25 to 150 psig; or wherein a temperature of the heated regenerant N₂ gas stream is in a range of 180° C. to 315° C.; or both.

A third embodiment of the invention is an apparatus for a semi-closed loop or closed loop regeneration process for a molecular sieve adsorber in a light olefin concentration unit comprising a heater having an inlet and an outlet; a molecular sieve adsorber having an inlet and an outlet, the molecular sieve adsorber inlet being in downstream fluid communication with the heater outlet; a cooler having an inlet and an outlet, the cooler inlet being in downstream fluid communication with the outlet of the molecular sieve adsorber; a knockout drum having an inlet and an outlet, the inlet of the knockout drum being in downstream fluid communication with the cooler outlet, an auxiliary molecular sieve adsorber having an inlet and an outlet, the auxiliary molecular sieve adsorber inlet being in downstream fluid communication with the knockout drum outlet, and the heater inlet being in downstream fluid communication with the auxiliary molecular sieve adsorber outlet. An embodiment of the invention is one, any or all of prior embodiments in this paragraph up through the third embodiment in this paragraph further comprising a compressor having an inlet and an outlet, the compressor inlet being in being in downstream fluid communication with the knockout drum outlet, and the auxiliary molecular sieve inlet being in being in downstream fluid communication with the compressor outlet. An embodiment of the invention is one, any or all of prior embodiments in this paragraph up through the third embodiment in this paragraph further comprising a second cooler having an inlet and an outlet, the second cooler inlet being in downstream fluid communication with the knockout drum outlet or an outlet of a compressor, and the auxiliary molecular sieve adsorber inlet being in downstream fluid communication with the second cooler outlet. An embodiment of the invention is one, any or all of prior embodiments in this paragraph up through the third embodiment in this paragraph further comprising a coalescer having an inlet and an outlet, the coalescer inlet being in downstream fluid communication with the knockout drum outlet, or an outlet of a compressor, or an outlet of a second cooler, the auxiliary molecular sieve inlet being in downstream fluid communication with the coalescer outlet. An embodiment of the invention is one, any or all of prior embodiments in this paragraph up through the third embodiment in this paragraph further comprising a regenerant gas inlet positioned between the knockout drum outlet and the auxiliary molecular sieve adsorber inlet. 28 An embodiment of the invention is one, any or all of prior embodiments in this paragraph up through the third embodiment in this paragraph further comprising a heat exchanger on a line to the regenerant gas inlet. An embodiment of the invention is one, any or all of prior embodiments in this paragraph up through the third embodiment in this paragraph further comprising a purge outlet positioned between the auxiliary molecular sieve adsorber outlet and the cooler inlet, or between the knockout drum outlet and the auxiliary molecular sieve adsorber inlet. An embodiment of the invention is one, any or all of prior embodiments in this paragraph up through the third embodiment in this paragraph wherein a vapor phase molecular sieve adsorber and a liquid phase molecular sieve adsorber share the semi-closed loop or closed loop regeneration apparatus.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A semi-closed loop or closed loop regeneration process for an adsorber comprising a molecular sieve comprising:
heating a dry regenerant gas stream forming a heated regenerant gas stream, wherein the dry regenerant gas stream comprises a vapor comprising a hydrocarbon having one to three carbon atoms;
introducing the heated regenerant gas stream into the adsorber to remove water from the adsorber forming a wet regenerant gas stream;
cooling the wet regenerant gas stream to form a cooled wet regenerant gas stream;
separating water from the cooled wet regenerant gas stream in a knockout drum forming a dehydrated regenerant gas stream and a water stream;
compressing the dehydrated regenerant gas stream with a compressor to form a compressed dehydrated regenerant gas stream; and
recycling the compressed, dehydrated regenerant gas stream to regenerate the adsorber.

2. The process of claim 1 wherein the dry regenerant gas stream comprises a C2 splitter overhead stream, or a deethanizer overhead stream, or a C3 splitter overhead stream, or combinations thereof, wherein the dry regenerant gas stream comprises a light olefin stream.

3. The process of claim 1 further comprising:
passing the dehydrated regenerant gas stream to a C2 splitter, or a deethanizer, or a C3 splitter, or combinations thereof.

4. The process of claim 3 wherein passing the dehydrated regenerant gas stream to the C2 splitter, or the deethanizer, or the C3 splitter or a product compressor, or an oxygenate absorber, or a DME stripper, or a caustic scrubber, or combinations thereof.

5. The process of claim 1 further comprising:
cooling the compressed dehydrated regenerant gas stream in a second cooler to produce a cooled compressed regenerant gas stream;
separating the cooled compressed regenerant gas stream in a coalescer to produce a second water stream and a second dehydrated regenerant gas stream; and
wherein the dry regenerant gas stream comprises the second dehydrated regenerant gas stream.

6. The process of claim 1 comprising;
dehydrating the second dehydrated regenerant gas stream in an auxiliary adsorber to produce a third dehydrated regenerant gas stream;
wherein the dry regenerant gas stream comprises the third dehydrated regenerant gas stream.

7. The process of claim 1 comprising;
introducing the heated regenerant gas stream into an auxiliary adsorber to remove water from the auxiliary adsorber forming a second wet regenerant gas stream.

8. The process of claim 2 further comprising;
passing the dry regenerant gas stream to a reactor to remove acetylenes to form a treated light olefin stream;
wherein the dry regenerant gas stream comprises the treated light olefin stream.

9. The process of claim 1 further comprising
replacing the dry regenerant gas stream with a second regenerant gas stream comprising nitrogen when the dry regenerant gas stream is not within a a desired range or when the dry regenerant gas stream is not available.

10. The process of claim 1 further comprising:
adding a make-up regenerant gas stream comprising regenerant gas to the dry regenerant gas stream, or the dehydrated regenerant gas stream, or a cooled dehydrated regenerant stream, or a cooled compressed dehydrated regenerant stream, or combinations thereof.

11. The process of claim 1 further comprising:
expanding the make-up regenerant gas stream before adding the make-up regenerant gas stream.

12. The process of claim 11 further comprising:
cooling a combination of the expanded make-up regenerant gas stream, and the dehydrated regenerant gas stream or a compressed dehydrated regenerant gas stream or a cooled dehydrated regenerant stream, or a cooled compressed dehydrated regenerant stream, or combinations thereof.

13. The process of claim 11 further comprising:
heat exchanging the expanded make-up regenerant gas stream with the cooled water laden regenerant gas stream, or the dehydrated regenerant gas stream, or a compressed dehydrated regenerant gas stream, or a cooled dehydrated regenerant gas stream, or a cooled compressed dehydrated regenerant gas stream, or combinations thereof.

14. The process of claim 1 further combining:
expanding the make-up regenerant gas stream before adding the make-up regenerant gas stream; and
combining the expanded make-up regenerant gas stream with the cooled water laden regenerant gas stream, or the cooled dehydrated regenerant gas stream, or a compressed dehydrated regenerant gas stream, or a cooled compressed dehydrated regenerant gas stream, or combinations thereof.

15. The process of claim 1 further comprising:
removing a purge regenerant gas stream from the dehydrated regenerant gas stream or the water laden regenerant gas stream.

16. The process of claim 1 further comprising:
compressing the dehydrated regenerant gas stream before removing additional water from the dehydrated regenerant gas stream.

17. The process of claim 1 further comprising:
cooling the dehydrated regenerant gas stream or the compressed dehydrated regenerant gas stream.

18. The process of claim 1 wherein a pressure of the regenerant gas stream is in a range of 40 to 350 psig; or wherein a temperature of the heated regenerant gas stream is in a range of 180° C. to 315° C.; or both.

19. The process of claim 1 further comprising:
introducing a supplemental regenerant gas comprising N₂ during a system start-up or during a system upset.

20. A semi-closed loop or closed loop regeneration process for an adsorber comprising a molecular sieve comprising:
heating a dry regenerant gas stream forming a heated regenerant gas stream, wherein the dry regenerant gas stream comprises a vapor comprising a hydrocarbon having one to three carbon atoms;
introducing the heated regenerant gas stream into the adsorber to remove water from the adsorber forming a wet regenerant gas stream;
cooling the wet regenerant gas stream to form a cooled wet regenerant gas stream;
separating water from the cooled wet regenerant gas stream in a knockout drum forming a dehydrated regenerant gas stream and a water stream;
compressing the dehydrated regenerant gas stream with a compressor to form a compressed dehydrated regenerant gas stream; and
recycling the compressed, dehydrated regenerant gas stream to regenerate the adsorber;
cooling the dehydrated regenerant gas stream or the compressed dehydrated regenerant gas stream; and
replacing the dry regenerant gas stream with a second regenerant gas stream comprising nitrogen when the dry regenerant gas stream is not within a desired range or when the dry regenerant gas stream is not available.
